(19) United States
(12) Patent Application Publication
(10) Pub. No.: US 2006/0286305 A1
(43) Pub. Date: Dec. 21, 2006

(54) Hydrophobic coatings comprising reactive nano-particles

(76) Inventors: Jens Christoph JC Thies, Maastricht (NL); Guido Jozefina Wilhelmus GJW Meijers, Stein (NL); Jonathan Andrew AJ Pitkin, King's Lynn (GB); Edwin E. Currie, Sittard (NL); Christopher Frederic CF Tronche, Schaumburg (GB); John Edmond JE Southwell, Elgin (GB)

Correspondence Address: NIXON & VANDERHYE, PC, 901 NORTH GLEBE ROAD, 11TH FLOOR, ARLINGTON, VA, 22203, US

(21) Appl. No.: 10/557,242

(22) PCT Filed: May 13, 2004
(86) PCT No.: PCT/NL04/00328

§ 371 Date: Apr. 18, 2006

(30) Foreign Application Priority Data
May 20, 2003 (NL) 03076509.3
May 20, 2003 (US) 60471745

(51) Int. Cl. C08F 2/48

(52) U.S. Cl. 427/508

(57) ABSTRACT

The invention relates to hydrophobic coatings comprising reactive inorganic nano-particles, as well as their use in industrial processes. These coatings combine hydrophobic or even super-hydrophobic properties with superior mechanical properties and easy proccessability. Some super-hydrophobic coatings may even have self-cleaning properties. These hydrophobic and super-hydrophobic coatings may be applied in the food industry, exterior or interior decoration, automobile industry and display industry. Also comprised within the invention are finished articles comprising a coating of inorganic nano-particles.

The invention relates to coating compositions and coatings comprising inorganic nano-particles, as well as their use in industrial processes. These coatings combine hydrophobic or even super-hydrophobic properties with superior mechanical properties and easy proccessability. Some superhydrophobic coatings may even have self-cleaning properties. These hydrophobic and superhydrophobic coatings may be applied in the food industry, exterior or interior decoration, automobile industry and display industry.

Hydrophobic coatings are becoming increasingly popular in numerous applications, such as windows, TV screens, DVD disks, cooking utensils, clothing, medical instruments etc because they are easy to clean and have low adhesive properties. Generally, a hydrophobic material or coating is characterised by a static contact angle of water (θ) of 90° or above. Hydrophobic polymeric materials such as poly(tetrafluorethene) (PTFE) or polypropylene (PP) have been available for decades. These materials suffer from a limited hydrophobicity, as well as inferior mechanical properties as compared to engineering materials or highly crosslinked coatings. For instance, PP has a static contact angle of water of roughly 100° whereas PTFE, which is amongst the most hydrophobic polymeric material known, has a static contact angle of water of roughly 112°.

Some hydrophobic coatings are being referred to In the art as superhydrophobic coatings. Superhydrophobic coatings are generally defined by a static water contact angle above 140° (Nun, Oles & Schleich, Macromol. Symp. 187 (2002)677-682).

Surfaces with superhydrophobic properties are found In nature, for example the lotus leaf or cabbage leaf. The waxes secreted onto the leaf's rough surface reduce the adhesion of water and contaminating particles to the leaf. Water droplets deposited on the leaf simply roll off, gathering dirt particles and cleaning the leaf in the process.

An enhanced hydrophobicity of coatings has been obtained via inclusion of micron-sized spherical particles in a silicone-based paint or polyolefin-based spray (BASF Press release Oct. 28, 2002, P345e, Dr. Karin Elbi-Weiser, Lotusan, Nature news service/Macmillan Magazines Ltd 2002). These suspensions are applied as paint or from a spray, yet suffer from a lack in mechanical robustness.

The abrasion resistance of such coatings is low and thus the coatings need to be reapplied after a short period of time to maintain the hydrophobic functionality of the surface. Additionally, the coating scatters light in the visible range, this effectively results in an opaque and optically non-transparent coating.

In U.S. Pat. No. 6,068,911, Hitachi described superhydrophobic coatings based also on the principle of surface roughness prepared via UV curing of resins containing non-reactive nano-particles and fluor polymers. Their coating formulation consists of at least two solvents, evaporation of the most volatile solvent drives the fluorpolymer to the surface, making it hydrophobic. The presence of the inert non-reactive nano-particles results in surface roughness and the overall coating exhibits superhydrophobicity. As this technology is based on the evaporation of an organic solvent to create surface roughness during processing, kinetics will play a role in this process. Also, the hardness, durability and abrasion resistance of the coating, leaves better performance to be desired.

The approach of Sunyx is to use a non-abrasion-resistant layer that is continuously replenished from a reservoir of mobile fluor-containing agents in an immobile matrix layer with on top a vapour-deposited top layer of inorganic material which has a large degree of roughness and cracks (WO 01/92179). The concept is that the fluorpolymers diffuse through the inorganic layer and cover the surface, thus forming a regenerative surface layer. This results in hard, optically clear surfaces with a high water contact angle and very low roll-off angle. However, the production of such complex structures via vapor deposition is very time-consuming and laborious, and the area size that can be coated is limited. Also, the release and washing away of the mobile fluorpolymers is environmentally not desirable.

There is a need therefore to obtain further (super)hydrophobic coatings that can more easily be applied and have controlled hydrophobicity and good durability (hardness, scratch resistance and adhesion).

Object of the present invention is to provide a coating compositions for such coatings.

Surprisingly this object is achieved by a coating composition comprising reactive nanoparticles having reactive organic groups and apolar groups on their surface.

Such reactive groups and apolar groups may simply be chemically grafted to the nano-particle surface. Examples may be nano-particles with acrylate groups, and apolar chains, e.g. perfluoralkyl chains.

Because of the presence of the reactive groups the nano-particles are part of a cross-linked network.

Because of the presence of the apolar groups, for example groups with a low dipole moment, the hydrophobic surface characteristics of the coating are obtained. This means that the apolar groups cause the static water contact angle (θ) to increase. Preferably the apolar groups on the surface of the nanoparticles comprise fluor atoms. Suitable reactive groups are for example acrylates, methacrylates, vinyls, thiol groups.

To obtain the composition according to the invention the reactive nano-particles may be mixed with the usual additives for initiation of the polymeric reaction and adhesion.

In a preferred embodiment the coating composition comprises the reactive nano-particles, at least one reactive diluent, a curing system and a solvent.

Those skilled in the art will now recognize that the coating properties can also be tuned towards e.g. improved hydrophobicity, improved hardness, improved impact strength etc by varying the ratio of reactive groups to apolar chains, the processing conditions, post-treatment etc.

Hydrophobicity of the coating may even further be improved if the coating composition comprises a reactive diluent having apolar groups. Preferably the apolar groups of reactive diluent comprise fluor atoms. The properties of a coating thus obtained may be tuned towards improved hydrophobicity, improved hardness, improved impact strength etc by varying the ratio of reactive to apolar groups, and/or the ratio of reactive nano-particles to reactive diluents in the coating, the polarity of the reactive diluents, the processing conditions and post-treatment. For the purpose of the invention, reactive diluents are defined herein as diluents containing reactive groups. These reactive groups are at least reactive with respect to each other and/or with respect to the reactive groups of the nano-particles.

Preferably the coating composition according to the invention comprises the reactive diluent in such an amount, that the static water contact angle (θ) of the coating is above 90° more preferably above 120°. Most preferably the coating composition according to the invention comprises an amount of reactive diluent in such an amount, that the static water contect angle (θ) of the coating is above 140°. Good results are obtained if the coating composition comprises 1-80 wt % of reactive diluent based on total solids In the composition. More preferably the composition comprises 25-80 wt. % of reactive diluent, most preferably 50-80 wt. % based on taotal solids in the composition.

Hydrophobic coatings with a great variety of properties may be obtained by the inclusion of the nano-particles, ranging from hard coatings with a low surface roughness to superhydrophobic coatings with a high surface roughness. Prefrably a coating composition is provided comprising reactive nanoparticles having a ratio of reactive groups and apolar groups and an amount of reactive diluent, so that a coating is obtained having 1) a static contact angle of water above 140°, preferably also 2) a hysteresis between advancing and receding water contact angles below 10°, more preferably also 3) a water droplet roll-off angle below 10°, and most preferably also 4) a limited difference in coloring of the coating during an extended soiling test.

Suitable nano-particles are particles of which the majority has a largest dimension of less than one micrometer. In a preferred embodiment, the majority of the nano-particles have a length of less than 350 nm. In a further preferred embodiment, the majority of the nano-particles have a diameter of less than 350 nm. More preferably all particles have a diameter less than 100 nm, more preferably less than 50 nm. Most preferably, particles used have such a diameter that they do not (significantly) influence the transparency of the eventual coating. Methods for determining the particle diameter include optical or scanning electron microscopy, or atomic force microscopy (AFM) imaging. For measuring the dimensions of the nano-particles the particles are in a very dilute mixture applied on a surface in a thin layer, so that at a SEM photographic image of the layer, the single nano-particles are observable. Than from 100 nanoparticles, ad random selected, the dimensions are determined and the average value is taken. In case of particles having an aspect ratio above 1, like worm-shaped nano-particles, the total length is determined, from one end to the other end, by following the primary axis as projected in the plane of the photo. For the diameter the longest straight line that can be drawn from one side of the particle to the other side, perpendicular to the primary axis is taken.

The nano particles used in the composition according to the invention may have a spherical shape. Preferably the nano-particles are elongated, having an aspect ratio above 1, more preferably above 2, still more preferably above 5, most preferably above 10. By using elongated nano-particles, a coating having good mechanical properties, good adhesion to substrates as well as good hydrophobic properties is obtained. Most preferably the particles are wormlike. This means that the primary axis is curved.

It is possible to use organic nano-particles, like for instance carbon nanotubes. Suitable inorganic particles are for example oxide particles. Preferred oxide particles are metal oxide particles such as aluminum oxide, siliciumoxide, zirconium oxide, titanium oxide, antimony oxide, zinc oxide, tin oxide, indium oxide, and cerium oxide. It is also possible to use a mixture of particles from different oxides or to use particles of mixed oxides. Preferably, the nano-particles are particles of aluminum oxide, zirconium oxide or silica oxide. The refractive index of the coating and effective refractive index of the coating/air interface can in part be tuned by the choice of oxide used. This is within the skills of a person skilled in the art.

Examples of suitable reactive groups are acrylates, methacrylates, vinyllic species or epoxies. One example of such a group is obtained when the nano-particle is reacted with a species according to formula 1.

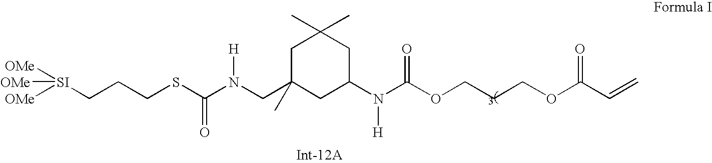

Combinations of groups that together may result in the formation of a crosslinked nerwork are for example carboxylic acids and/or carboxylic anhydrides combined with epoxies, acids combined with hydroxy compounds, especially 2-hydroxyalkylamides, amines combined with isocyanates, for example blocked isocyanate, uretdion or carbodiimide, epoxies combined with amines or with dicyandiamides, hydrazinamides combined with isocyanates, hydroxy compounds combined with isocyanates, for example blocked isocyanate, uretdion or carbodiimide, hydroxy compounds combined with anhydrides, hydroxy compounds combined with (etherified) methylolamide (“amino-resins”), thiols combined with isocyanates, thiols combined with groups comprising vinyl unsaturations, as for example acrylates (optionally radical initiated), acetoacetate combined with acrylates, and when cationic crosslinking is used epoxy compounds with epoxy or hydroxy compounds.

Further compounds that may be used as reactive groups are moisture curable isocyanates, moisture curable mixtures of alkoxy/acyloxy-silanes, alkoxy titanates, alkoxy zirconates, or urea-, urealmelamine-, melamine-formaldehyde or phenol-formaldehyde (resol, novolac types), or radical curable (peroxide-or photo-initiated) ethylenically unsaturated mono-and polyfunctional monomers and polymers, e.g. acrylates, methacrylates, maleate/vinyl ether), or radical curable (peroxide-or photo-initiated) unsaturated e.g. maleic or fumaric, polyesters in styrene and/or in methacrylates.

Reactive nano-particles may be made hydrophobic by chemically grafting apolar groups to the surface. In principle, any method for chemical grafting of apolar groups to inorganic nano-particles may be used. The grafting step may for instance be performed using for instance trimethoxy silane species with a hydrophobic group, for example a species according to formula II.

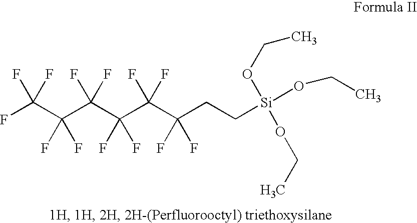

Examples of this are perfluorhexyl ethyl trimethoxysilane, perfluoroctyl ethyl trimethoxysilane or perfluordecyl ethyl trimethoxysilane. Alternatives could be other alkoxysilane perfluor alkyls or alkoxy silane dimethyl siloxanes.

Preferably the coating composition comprises one or more reactive diluents. The reactive diluents include monoreactive diluents, i.e. molecules with one reactive group, or multireactive diluents, i.e. molecules with two or more reactive groups. The resulting properties of the coating depend on the choice and amount of reactive diluents. The nature of the reactive diluent preferably is apolar, and preferred species include fluor-containing species or dimethylsiloxane-containing species. Most preferred diluents include perfluoroalkyl monoacrylates, perfluoroalkyl monomethacrylates, polydimethylsiloxane monoacrylates, polydimethylsiloxane monomethacrylates, perfluoro polyether monoacrylates, perfluorinated polyether monomethacrylates, polydimethyl siloxanes polyether monoacrylates, polydimethyl siloxanes polyether monomethacrylates.

In the case of multireactive diluents the mechanical properties will be even superior to that of hydrophobic coating compositions comprising solely reactive inorganic nano-particles. Examples of such diluents may include perfluoralkyl diacrylates, and polydimethylsiloxane diacrylates.

In another embodiment of the invention, the coating formulation may comprise non-reactive diluents, which do not fall under the common class of additives species, e.g. photoinitiators, adhesion promotors or anti-oxidants. Such non-reactive diluents may exhibit surface activity, thus allowing diffusion of the diluent to the coating surface. Examples of such diluents may Include but are not limited to perfluoralkyls, polydimethylsiloxanes, perfluor polyethers, polydimethyl siloxanes polyethers, polydimethylsiloxanes containing alkyl chains etc.

The coating composition according to the invention may be applied to substrates that are for example flat or curved, rigid or flexible, and include both organic and inorganic substrates. Examples of suitable substrates include films of polycarbonate, polyester, polyvinyl acetate, polyvinyl pyrollidone, polyvinyl chloride, polyimide, polyethylene naphthalate, polytetrafluoro ethylene, nylon, polynorbornene. Metals, amorphous or crystalline solids may also be used as substrate, including for example steel, glass or crystalline materials, such as for example silicon or gallium arsenide.

The coating composition may contain a substrate specific adhesion promoter defined as a component that improves the adhesion of the coating to the substrate. The adhesion promoter is preferably included in the coating composition before deposition in an amount ranging from 0.1 to 5 wt % based on the total weight of compounds in the coating composition. Suitable promoters for the adhesion of the film or coating to a glass or other substrates are for example acrylated trimethoxy silane monomers. Examples of silane adhesion promoters include: γ-mercaptopropylmethylmonomethoxysilane, γ-mercaptopropylmethyldimethoxysilane, γ-mercaptopropyltrimethoxysilane, γ-mercaptopropylmonoethoxysilane, γ-mercaptopropyidiethoxysilane, γ-mercaptoethylmonoethoxysilane, β-mercaptoethyltriethoxysilane, β-mercaptoethyltriethoxysilane, β-mercaptoethyltriethosysilane, N-(2-aminoethyl)-3-aminopropylmethyldimethoxysilane, N-(2-aminoethyl)-3-aminopropyltrimethoxysilane,γ-aminopropyltriethoxysilane, γ-glycidoxylpropyltrimethoxysi lane, γ-glycidoxyl propylmethyldimethoxysilane, 2-(3,4-epoxycyclohexyl)ethyltrimethoxysilane, γ-chloropropylmethyidimethoxysilane, γ-chloropropyltrimethoxysilane, and γ-methacryloyloxypropyltrimethoxysilane. Examples of commercially available products of these compounds include SILAACE S310, S311, S320, S321, S330, S510, S520, S530, S610, S620, S710, S810 (manufactured by Chisso Corp.), Silquest A-174NT (manufactured by OSI Specialties—Crompton Corp.). SH6062, AY43-062, SH6020, SZ6023, SZ6030, SH6040, SH6076, SZ6083 (manufactured by Toray-Dow Corning Silicone Co., Ltd.), KBM403, KBM503, KBM602, KBM603, KBM803, KBE903 (manufactured by Shin-Etsu Silicone Co., Ltd.), and the like. Also acidic adhesion promoters such as acrylic acid may be used. Phosphate esters such as Eb168 or Eb170 from UCB are feasible adhesion promoters.

Surprisingly, it has been found that for substrates containing vinyllic unsaturation, for example acrylate or methacrylate based substrates, like a crosslinked coating, for example a hard coat, compounds comprising at least one thiol group are very suitable as adhesion promoters. Such thiol compounds may be mono-functional, di-functional, preferably tri-functional and most preferably tetra-functional with respect to the number of thiol groups per molecular species. The thiol compounds may comprise next to the thiol group a further reactive group. In case the thiol compound comprises only one thiol group, it must comprise at least one further reactive group. Examples of thiol compounds are Polythiol ingredients may be any of those known in the art. A description of the most common thiol compounds may be found at column 9, lines 1-41 of U.S. Pat. No. 3,661,744, which is incorporated herein by reference. Certain polythiols such as the aliphatic monomeric polythiols (ethane dithiol, hexamethylene dithiol, decamethylene dithiol, tolylene-2,4-dithiol, and the like, and some polymeric polythiols such as a thiol-terminated ethylcyclohexyl dimercaptan polymer, and the like, and similar polythiols which are conveniently and ordinarily synthesized on a commercial basis are operable. Examples of the polythiol compounds preferred because of relatively low odor level include but are not limited to esters of thioglycolic acid (HS—CH₂COOH), a-mercaptopropionic acid (HS—CH(CH₃)—COOH and β-mercaptopropionic acid (HS—CH₂CH₂COOH) with polyhydroxy compounds such as glycols, triols, tetraols, pentaols, hexaols, and the like. Specific examples of the preferred polythiols include but are not limited to ethylene glycol bis(thioglycolate), ethylene glycol bis(β-mercaptopropionate), trimethylolpropane tris(thioglycolate), trimethylolpropane tris(β-mercaptopropionate), pentaerythritol tetrakis(β-mercaptopropionate), all of which are commercially available. A specific example of a preferred polymeric polythiol is polypropylene ether glycol bis(β-mercaptopropionate) which is prepared from polypropylene-ether glycol (e.g. Pluracol P201, Wyandotte Chemical Corp.) and β-mercaptopropionic acid by esterfication. Poly-o-mercaptoacetate or poly-β-mercaptopropionate esters, particularly the trimethylopropane triesters or pentaerythritol tetra esters are preferred. Other polythiols which can be suitably employed include alkyl thiol functional compounds such as 1,2-dimercapthoethane, 1,6-dimercaptohexane and the like. Thiol terminated polysulfide resins may also be employed.

Suitable examples of aliphatic dithiols include 1,2-ethanedithiol, butanedithiol, 1,3-propanedithiol, 1,5-pentanedithiol, 2,3-dimercapto-1-propanol, dithioerythritol, 3,6-dioxa-1,8-octanedithiol, 1,8-octanedithiol hexanedithiol, dithiodiglycol, pentanedithiol,decanedithiol, 2-methyl 1,4 butanedithiol, bis-mercaptoethylphenyl methane, 1,9-nonanedithiol(1,9-dimercaptononane), glycol dimercaptoacetate.

Suitable examples of aromatic dithiols include 1,2-benzenedithiol, 1,3-benzenedithiol, 1,4-benzenedithiol, 2,4,6-trimethyl-1,3-benzenedimethanethiol, durene-α1 , α2-dithiol , 3,4-dimercaptotoluene, 4-methyl-1,2-benzenedithiol, 2,5-dimercapto-1,3,4-thiadiazole, 4,4′-thiobisbezenedithiol, bis(4-mercaptophenyl)-2,2′-propane(bisphenol dithiol) (made according to the method of Meng Y. Z., Hay. A. S., J. of App. Polym. Sci., V74, 3069-3077(1999).

Suitable examples of oligomeric dithiols include difunctional mercapto functional urethane oligomers derived from end capping moieties of hydroxyethyl mercaptan, hydroxypropyl mercaptan, dimercaptopropane, dimercapto ethane as described in patent by Shustack U.S. Pat. No. 5,744,514.

Examples of suitable trithiol functional compounds include, trimethylolethane tris-mercaptopropionate, trimethylolpropane tris-mercaptopropionate (TMPTSH), trimethylolethane tris-mercaptoacetate, and trimethylolpropane tris-mercaptoaacetate glycerol tri(11-mercaptoundecanoate), trimethylol propane tri(11-mercaptoundecate). A preferred trithiol is trimethylolpropane tris(2-mercapto-propionate) TMPTSH.

Examples of suitable tetrafunctional thiols include pentaerythritol tetramercapto propionate, pentaerythritol tetramercapto acetate, and pentathritoltetra(11-mercaptoundecate)

Examples of multifunctional thiols having functionality greater than 4, include polythiols as described on page 7 of WO 88/02902.

Multi functional thiols can be obtained by reacting thioalkyl carboxylic acids e.g. thioglycolic acid, mercapto propionic acid with high functional alcohols, amines and thiols. Furthermore, multifunctional thiols can be obtained by reacting mercapto alkyl trialkoxy silanes with silanols that may be polymeric or silica based silanols.

Other preferred multifunctional thiols are obtained using thiol carboxylic acids (HS—R—COOH) where R=alkyl, or aryl groups eg thioundecanoic acid of which the COOH groups are reacted with reactive enes, alcohols, thiols or amines that are multifunctional.

The adhesion promoters may be used In an amount of 0.1-10 wt-% of the total solids in the mixture, after evaporation of the solvent. Preferably the adhesion promoter is used in an amount of 5-10 wt-%.

The coating composition according to the invention may comprise any further additive. This may include, but is not limited to UV-stabilisers or oxydative stabilisers. The coating composition may also contain stabilizers such as hydro quinone mono ethyl ether (HQMME), surface derivatizing agents, such as methyl trimethoxysilane (MTMS) and/or dehydrating agents like ortho methyl formate (OFM).

The reactive nano-particles are typically added to the coating composition in the form of a suspension. The same solvent as used for the suspension may be used to adjust the coating composition so that it has the desired properties. However, other solvents may also be used. Examples of solvents that may be suitable are 1,4-dioxane, acetone, acetonitrile, chloroform, chlorophenol, cyclohexane, cyclohexanone, cyclopentanone, dichloromethane, diethyl acetate, diethyl ketone, dimethyl carbonate, dimethylformamide, dimethylsulphoxide, ethanol, ethyl acetate, m-cresol, mono-and di-alkyl substituted glycols, N,N-dimethylacetamide, p-chlorophenol, 1,2-propanediol, 1-pentanol, 1-propanol, 2-hexanone, 2-methoxyethanol, 2-methyl-2-propanol, 2-octanone, 2-propanol, 3-pentanone, 4-methyl-2-pentanone, hexafluoroisopropanol, methanol, methyl acetate, methyl acetoacetate, methyl ethyl ketone, methyl propyl ketone, n-methylpyrrolidone-2, n-pentyl acetate, phenol, tetrafluoro-n-propanol, tetrafluoroisopropanol, tetrahydrofuran, toluene, xylene and water. Alcohols, ketones and esters based solvents may also be used, although the solubility of acrylates may become an issue with high molecular weight alcohols. Halogenated solvents (such as dichloromethane and chloroform) and hydrocarbons (such as hexanes and cyclohexanes), may also be suitable.

Any cross-linking method that may cause the reactive Inorganic nano-particles and optionally reactive diluents to crosslink is suitable to be used in the process according to the invention. Suitable ways to initiate crosslinking are for example electron beam radiation, electromagnetic radiation (UV, Visible and Near IR), thermally and by adding moisture, in case moisture curable compounds are used. In a particularly easy and thus preferred embodiment crosslinking is achieved by UV-radiation. The UV-crosslinking may take place through a free radical mechanism or by a cationic mechanism, or a combination thereof. In another preferred embodiment the crosslinking is achieved thermally, in that way coatings may be obtained with a high glass transition temperature (Tg) that usually have better mechanical properties.

After crosslinking one or more additional processing steps may be performed, for instance a thermal treatment to enhance the crosslinking and adhesion to the substrate.

A polymerization initiator may also be present In the coating composition to initiate the crosslinking reaction. The amount of initiator may vary between wide ranges. A suitable amount of initiator is for example between 0.01 and 5 wt % with respect to total weight of the compounds that take part in the crosslinking reaction. When UV-crosslinking is used to initiate crosslinking, the mixture preferably comprises a UV-photo-initiator. A photo-initiator is capable of initiating a crosslinking reaction upon absorption of light, thus, UV-photo-initiators absorb light in the Ultra-Violet region of the spectrum. Any known UV-photo-initiators may be used in the process according to the invention.

The invention also relates to a coating obtained from the coating composition according to the invention.

The invention also relates to a process for obtaining a substrate with the coating according to the invention, comprising the steps of:

Providing a substrate

Applying a coating composition according to the present invention to the surface of the substrate

Crosslinking the coating composition.

It is a major advantage of the present invention that the coating may be applied onto the substrate by any process known in the art of wet coating deposition. Examples of suitable processes are spin coating, dip coating, spray coating, flow coating, meniscus coating, capillary coating and roll coating.

In a preferred embodiment an object is provided that is coated in a pattern of the coating according to the invention and a non hydrophobic coating or the substrate itself. Patterning of the coatings and/or the substrate via curing of deposited coatings may be achieved through masks. Crosslinking in that case is then advantageously done via electromagnetic radiation which allows easy hydrophobic/hydrophilic patterning of surfaces. This is of interest for instance for surfaces of microarrays or microfluidic devices where fluids may be guided through hydrophobic and hydrophilic patterning,

In a further Improved embodiment the substrate is in a first step coated with a first coating, preferably a highly crosslinked coating or a hard coat, and in a second step the mixture according to the present invention is applied on top of the first coating. In this way the first coating acts as the substrate for the mixture of the present invention. In this case the first coating comprises vinyllic unsaturations and thiol compounds are preferably used as adhesion promoters. In this way a still better scratch resistance of the coating of the present invention is obtained.

Suitable examples for the first coating are the coatings described in EP-A-1276810.

Preferably in the first step of application of the first coating, the first coating is partly cured at least at the surface. In case that in the hard coat, a radical curing resin system is used, like for example an acrylate based resin system, partly surface curing is preferably obtained by curing in the presence of oxygen, for example curing in an air atmosphere. In this way a still further improved adhesion between the hard coating and the antireflective coating is obtained, resulting in a still further improvement of the scratch resistance of the coating according to the present invention.

The scratch resistance can be still further improved by thermally treating the first coating and the coating according to the invention, by for example Infra red lamps or thermal ovens. Good results are obtained if the coating according to the invention and preferably also the first coating comprise a thermal initiator for subsequent cross-linking during thermal post-treatment, especially if the cure of hard coat and nano-structured coatings has been induced photo-chemically. The skilled artisan knows how to select such a thermal initiator.

To characterise the hydrophobicity of the prepared coatings, contact angle measurements were performed on various coatings. To correlate the surface roughness on a nanometer scale with the overall water contact angle, the surface topography was measured using a Digital Instruments atomic force microscope (AFM). The analysis was performed on sections between 2×2 micron and 10×10 micron. To analyze the roughness of the different coatings quantitatively, several parameters were calculated using Scanning Probe Image Processor software of Image Metrology. One of the methods was calculation of the Abbott curve.[K. J. Stout & L. Blunt, Three-dimensional Surface Topography, Penton Press, 1994.]. This curve gives a good indication of the overall surface roughness.

A second useful parameter is the fractal dimension of the coating. This is a measure of the irregularity of the surface and for a coating varies between a value of 2 (perfect flat surface) and three (highest surface roughness possible). The relationship between fractal dimension and (super)hydrophobicity is already examined theoretically by Feng et al. [L. Feng et al, Advanced Materials, 14, 1857, 2002]. Overall, for an intrinsic hydrophobic material a higher surface fractal dimension gives a higher water contact angle.

In order to determine mechanical properties of the coating, nanoindentation tests were performed on several coatings in which the hardness, reduced modulus and scratch resistance were measured. The coatings comprising reactive inorganic particles have the desired high values of hardness and scratch resistance.

### FIGURE LEGENDS

FIG. 1: static water contact angle of coatings of formulations comprising nano-particles D-H.

FIG. 2: static water contact angle of coatings comprising formulations described in Table 4.

FIG. 3: Topography of coating from formulation 14.

FIG. 4: Abbott curves of coatings from formulations 6, 7, 8, 9 & 14. FIG. B is an enlargement of a section of figure A

FIG. 5: Typical load function used for nanoindentation of coatings

FIG. 6: Typical response curve of nanoindented coatings.

### EXAMPLES

### Example 1

### Preparation of Hydrophilic Acrvlate Reactive Nano-Particles for Reference Purposes in Comparative Examples

Nano-silicate particles where obtained from Nissan Chemical American Corporation. Two types of nano-silicate particles were used in illustration of the invention and their properties are listed in table 1A below.

TABLE 1A
Types and properties of nano-silica particles.

| Nano- | Particle | SiO₂ | H₂O | Viscosity | Specific | | Particle | |
|---|---|---|---|---|---|---|---|---|
| particle | Size (nm) | (wt %) | (%) | (mPa · s.) | Gravity | pH | Shape | Solvent |
| MT-ST | 10-15 | 30-31 | <2.0 | <5 | 0.98-1.02 | 2-4 | Spherical | Methanol |
| IPA-ST- | 9-15 | 15-16 | <1.0 | <20 | 0.85-0.90 | 2-4 | Elongated* | Iso- |
| UP | Elongated* | | | | | | | propanol |

*Elongated particles have a diameter of 9-15 nm with a length of 40-300 nm. (Information source www.snowtex.com).

The materials used in obtaining hydrophilic nano-particles with only acrylate groups are shown in Table 1B. Nanosilica oxide particles (MT-ST) were modified by adding a trimethoxy-silane compound comprising as an acrylate group int-12a together with a compound that inhibits polymeriza HQMME, to a suspension of the nanosilica oxide particles in methanol. A small amount of water present in the MT-ST suspension (1.7 w % of total MT-ST) facilitated the silane grafting reaction. During stirring the mixture was refluxed for at least three hours at 60° C. Following this, an alkoxy silane compound, MTMS, was added and the resultant mixture was stirred and refluxed at 60° C. for at least one hour. A dehydrating agent, OFM, was added and the resultant mixture was stirred and refluxed at 60° C. for at least one hour.

TABLE 1B
Compounds in weight percentage used for preparation of reference nano-
particles A (not comprising apolar groups)

| Material | nano-particle A |
|---|---|
| MT-ST (nanosilica oxide, particle size 10-15 nm) | 24.75% |
| Int-12A (trimethoxy silane acrylate coupling agent) | 7.84% |
| HQMME (Hydroquinnone mono-methylether, stabilizer) | 0.14% |
| MTMS (Methyltrimethoxysilane, surface derivatizating | 1.23% |
| agent) | |
| Methanol (solvent) | 57.75% |
| OFM (Trimethyl orthoformate, dehydrating agent) | 8.29% |
| Total | 100% |

The materials used in obtaining elongated, non-spherical reactive nano-particles containing acrylate groups and fluor groups are shown in Table 1C

TABLE 1C
Compounds in weight percentage used for preparation of
reactive elongated nano particles (comprising apolar groups)

| | nano-particle B |
|---|---|
| | (Acry-F-IPA-ST- |
| Material | UP) |
| IPA-ST-UP elongated nano-silica | 14.37 wt-% |
| Particle diameter 9-15 nm | |
| Particle length 40-300 nm | |
| Int-12A (trimethoxy silane acrylate coupling agent) | 1.17 wt-% |
| Hydroquinnone mono-methylether | 0.038 wt-% |
| (HQMME stabiliser) | |
| Methyltrimethoxysilane | |
| (MTMS surface derivatisation agent) | |
| 1H,1H,2H,2H-(Perfluorooctyl) triethoxysilane (apolar | 0.678 wt-% |
| surface derivatisation agent) | |
| Methanol (solvent) | 1.15 wt-% |
| Isopropanol (solvent) | 81.40 wt-% |
| Trimethyl orthoformate | 1.19 wt-% |
| OFM (dehydrating agent) | |
| Total | 100 wt-% |

### Example 2

### Preparation of Hydrophobic Reactive Nano-Particles C. D-G and Reference Particles H

The materials used in obtaining hydrophobic reactive nano-particles containing acrylate as reactive groups and fluor as apolar groups are shown in Table 2. Nanosilica oxide particles (MT-ST) were stabilized by adding a trimethoxy-silane compound comprising an acrylate group Int-12a (formula I) together with a compound that inhibits polymerization of the acrylate groups, HQMME, to a suspension of the nanosilica oxide particles in methanol. A small amount of water present in the MT-ST suspension (1.7 w % of total MT-ST) facilitated the silane grafting reaction. During stirring the mixture was refluxed for at least two hours at 60° C. Following this, an perfluoralkyl trimethoxysilane compound, TDFTEOS (formula II), was added and the resultant mixture was stirred and refluxed at 60° C. for at least two hours. A dehydrating agent, OFM, was added and the resultant mixture was stirred and refluxed at 60° C. for one hour. This resulted in a coating composition containing hydrophobic reactive nano-particles comprising acrylate and fluor groups. This coating composition is further rerferred to as composition C and the nano-particles contained therein are referred to as nano-particles C.

TABLE 2
Compounds in weight percentage used for preparation of hydrophobic
reactive nano-particle C (comprising apolar groups).

| Material | Nano particle C |
|---|---|
| MT-ST (nano-silica oxide, particle size 10-15 nm) | 23.81 |
| Int-12A (trimethoxy silane acrylate coupling agent) | 7.71 |
| HQMME (Hydroquinnone mono-methylether, | 0.14 |
| stabilizer) | |
| TDFTEO, 1H,1H,2H,2H-Perfluoro-octyltrimethoxysilane | 4.63 |
| (surface derivatizating agent) | |
| Methanol | 55.55 |
| OFM (Trimethyl orthoformate, dehydrating agent) | 8.17 |
| Total | 100 |

Using the same method, four additional coating compositions containing hydrophobic reactive nano-particles D-G were prepared. Also, a reference particle without any acrylate groups (nano-particle H) was prepared. This is summarized in Table 3. In these cases, additional water was added at the beginning of the reaction, and additional OFM after completion.

TABLE 3
Compounds in weight percentage used for preparation of hydrophobic reactive
nano-particles D-G and reference nano-particle H

| | | | | | Reference |
|---|---|---|---|---|---|
| | nano | nano | nano | nano | nano |
| Material | particle D | particle E | particle F | particle G | particle H |
| MT-ST (nano-silica oxide, particle | 23.15 | 23.02 | 23.48 | 23.59 | 23.67 |
| size 10-15 nm) | | | | | |
| Int-12A (trimethoxy silane | 7.41 | 9.76 | 3.36 | 1.35 | 0 |
| acrylate coupling agent) | | | | | |
| HQMME (Hydroquinnone mono- | 0.13 | 0.14 | 0.14 | 0.14 | 0.14 |
| methylether, stabilizer) | | | | | |
| TDFTEO (1H,1H,2H,2H- | 4.36 | 2.47 | 7.13 | 8.69 | 9.61 |
| Perfluorooctyltrimethoxysilane, | | | | | |
| surface derivatizating agent) | | | | | |
| Methanol | 51.22 | 50.92 | 51.95 | 52.18 | 52.38 |
| Water | 1.97 | 1.96 | 2.00 | 2.02 | 2.04 |
| OFM (Trimethyl orthoformate, | 11.75 | 11.73 | 11.94 | 12.03 | 12.15 |
| +UZ,22/25 +UZ,27/30 +UZ,32/35 +UZ,37/40 dehydrating agent) | | | | | |
| Total | 100 | 100 | 100 | 100 | 100 |

### Example 3

### Preparation of Coating Compositions Containing Hydrophobic Reactive Nano-Particles and Diluent

Solutions of hydrophobic acrylate reactive fluor-containing nano-particle C prepared as described in Example 2 were mixed with varying ratios of perfluordecyl monoacrylate, obtained from ABCR, and varying amounts of the radical photoinitiator Irgacure 184, obtained from Ciba. The hydrophilic nano-particle A as described in Example 1 was chosen as a reference for hydrophobicity, to which 0.25 w % (with respect to solids) Irgacure 184 photoinitiator was added. The compositions of the formulations are shown in Table 4. In this way, a series of coating compositions containing reactive nano-particles was obtained with increasing fluor to acrylate ratio.

TABLE 4
Formulations 6-17 wherein reactive nano-particle C was mixed with reactive
diluent (in this case perfluordecyl mono acrylate).

| | Formulation no. | | | | | | | | | | | |
|---|---|---|---|---|---|---|---|---|---|---|---|---|
| | 6 | 7 | 8 | 9 | 10 | 11 | 12 | 13 | 14 | 15 | 16 | 17 |
| Material | mg | mg | mg | mg | mg | mg | mg | mg | mg | mg | mg | mg |
| Hydrophobic | 1079 | 287 | 269 | 361 | 221 | 192 | 160 | 140 | 129 | 93 | 88 | 52 |
| reactive nano- | | | | | | | | | | | | |
| particle C | | | | | | | | | | | | |
| Perfluordecyl mono | 0 | 65 | 150 | 360 | 301 | 322 | 336 | 364 | 435 | 408 | 578 | 960 |
| acrylate | | | | | | | | | | | | |
| Photo initiator | 3.1 | 1.45 | 1.55 | 1.8 | 1.4 | 1.65 | 1.55 | 1.8 | 1.45 | 1.7 | 1.95 | 2.4 |
| (Irgacure 184) | | | | | | | | | | | | |
| Methanol | 1978 | 538 | 508 | 676 | 419 | 373 | 315 | 283 | 258 | 198 | 194 | 138 |

### Example 4

### Preparation of Spincoated Coatings from Formulations Containing Hydrophobic Reactive Nano-Particles

The formulations 6-17, as shown in Table 4, were spin-coated on substrates using a standard CONVAC spincoater. A drop of these formulations was deposited on either a glass or a silicon wafer spinning at a speed of 4800 rpm. The resultant thin wet film after spincoating was crosslinked with UV using a D-bulb under nitrogen at a dose of 1.7 J/cm2. All samples were postbaked in an oven at 70° C. for one hour. The thickness of the crosslinked transparent coating on silicium wafers was measured with a multi-spectral reflectometer (F20, AG Electro optics). In the case of formulations 7-17 the coating roughness was too large to measure the thickness using spectral reflectometry. Their thickness was estimated to be in the range of 1-5 micron.

TABLE 5
Thickness of coating after reaction of several formulations with different
solid concentrations.

| | wt % of solids | |
|---|---|---|
| | in methanol | Thickness (nm) |
| Formulation 6 | 36 | 1430 |
| Formulation 6 | 10.8 | 159 |
| Formulation 6 | 4.5 | 88 |
| Reference nano-particle A + 0.25 w % | 5 | 83 |
| Irgacure 184 | | |
| formulations 7 to 17 | 40-60 | Too rough to |
| | | measure |

It may be concluded from these experiments that the thickness of the coatings strongly increases with the wt % of solids in solvent.

### Example 5

### Measurement of Water Contact Angle

The static contact angles were measured using the FTA (First Ten Angstroms) 200 apparatus. This piece of equipment consists of a motorised syringe pump, a sample stage and a video camera. The software used with the system is FTA Video drop shape analysis version 1.98 Build B. Before any measurements were carried out the surface tension of the water in the syringe was measured and was found to be between the values 70-74 mNm⁻¹. The static contact angle of a coating was measured by dispensing a 12 μl droplet of distilled water onto the surface. A 130 second video clip of the droplet was taken consisting of 65 images in total. From the form of the droplet, the contact angle was calculated. At least 2 different areas of a given coating were measured, the average of these measurements is quoted as the static water contact angle.

### Example 6

### Static Water Contact Angles on Coatings Comprising Hydrophobic Nano-Particles D-H

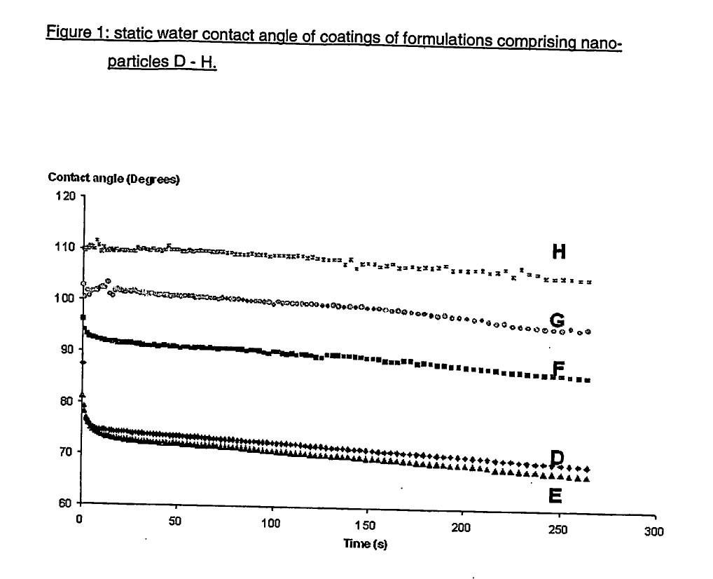

Coatings were spincoated on a silicium wafer according to Example 4. The static water contact angle was measured according to Example 5, the results are shown In FIG. 1. Evidently, the water contact angle increased with increasing fluor to acrylate ratio on the nano-particle. All contact angles of formulations containing nano-particles D-H were significantly higher than that of the reference hydrophilic nano-particle A, which was 55.9°. Evidently, nano-particle H had the highest contact angle, however, as this nano-particle has no acrylate groups, this results in a non-crosslinked coating which lacks any mechanical or adhesive properties.

### Example 7

### Measurement of Static Water Contact Angles of Coatings from Formulations 6-17 (All Coatings Comprising Particles C)

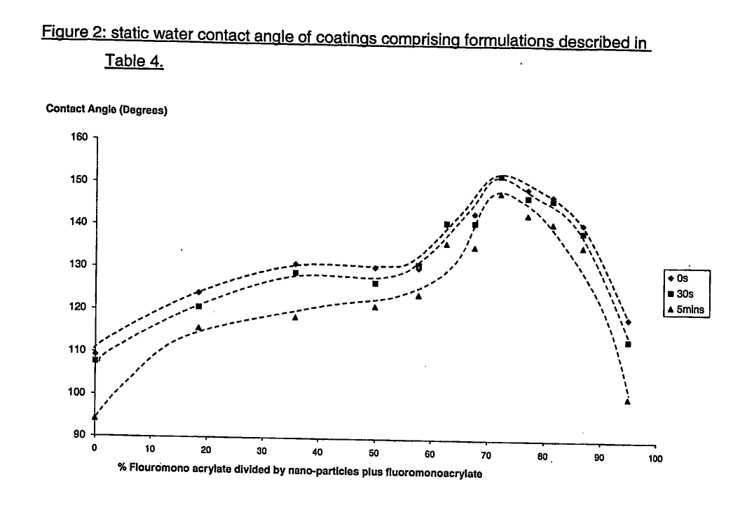

Coatings on silicium wafers were prepared from formulations 6-17, as described in Example 4. The static water contact angle of these coatings, measured according to Example 5, is shown in FIG. 2. In FIG. 2 the static water contact angle is plotted against the relative amount of reactive diluent (in this case perfluor decyl monoacrylate) divided by the total amount of acrylate reactive species (in this case perfluor decyl monoacrylate plus reactive particle). From the figure it is evident that Formulation 13 had an optimum water contact angle of above 150° when a ratio of reactive diluent versus total reactive groups of 72% was used.

### Example 8

### Measurement and Analysis of Surface Topography of Coatings from Formulations 6, 7, 8, 9 & 14

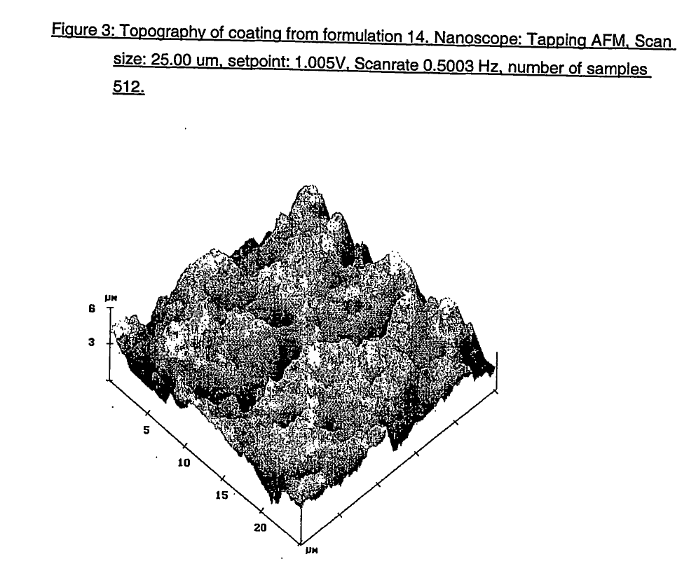

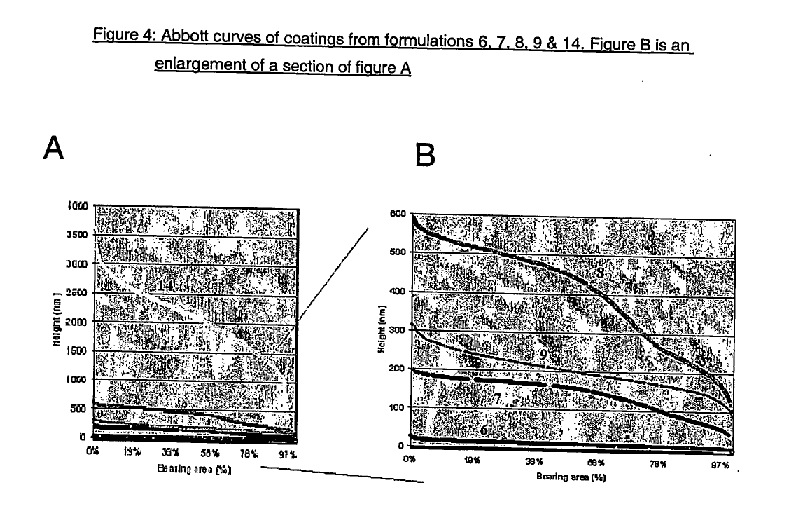

The surface topography of the coatings of formulations, prepared according to Examples 1-3, was measured using an Atomic Force Microscope (AFM) of Digital Instruments in tapping mode. The topography of a coating obtained with composition 14 is shown in FIG. 3. For some other compositions, the values for the average width and height of the surface protrusions together with the maximum height difference are given in Table 6. As is clear from Table 6, the lateral and vertical roughness varied with the composition of the formulation. A useful way to present the AFM results is to use a so-called Abbott curve, in which the percentage of a plane at a given depth of measurement covered by material is plotted as a function of this distance. The results, shown in FIG. 4, show that the vertical distribution of material was much larger in the case of Formulation 14 than that of Formulation 6, 8 or 9. The increasing roughness of the coatings of formulations 6, 8, 9 & 14 corresponded with the increasing static water contact angle, as shown in FIG. 2.

TABLE 6
AFM data of coatings from formulations 6, 8, 9 & 14.

| | Average | Average | |
|---|---|---|---|
| Formulation | feature Height (nm) | feature width (nm) | Rmax (nm) |
| 6 | 5 | <50 | 19 |
| 8 | 400 | 800 | 616 |
| 9 | 100 | 500 | 252 |
| 14 | 500 | 2000 | 3000 |

### Example 9

### Measurement of Mechanical Properties via Nanoindentation

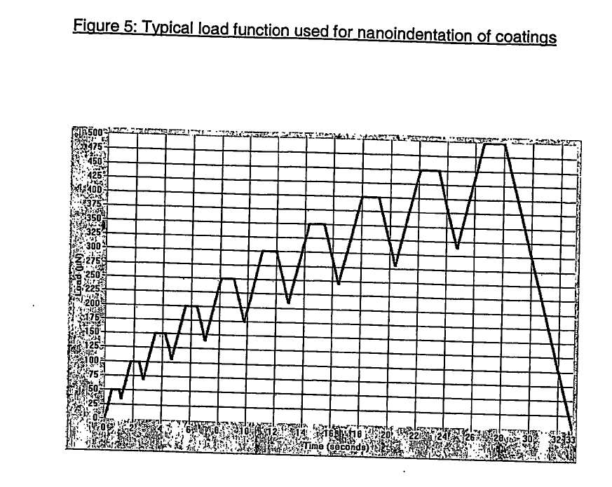

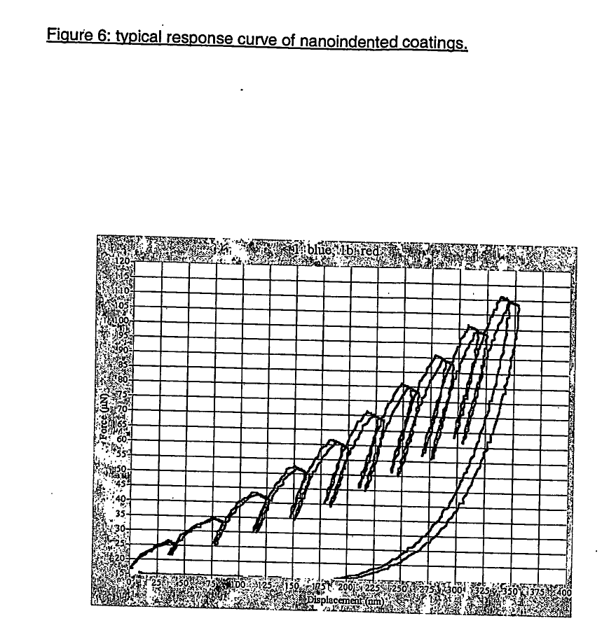

The hardness and reduced modulus of two coatings prepared according to Example 4 on a silicium wafer, was measured via nanoindentation. The nanoindentation measurements were performed with a Hysitron TriboScope, using a calibrated Berkovich diamond tip as indenter. The tip was inserted into the coatings with a known load, and the penetration depth in the coating was recorded. A typical load function used is shown in FIG. 5, a typical resultant force-displacement curve is shown in FIG. 6. The hardness was calculated via the relationship H (in GPa)=Fmax/24.5 d², where Fmax is the highest load applied and d is the penetration depth. The reduced modulus was calculated from the force-displacement curve Er=0.5 (π/24.5 d²)^{1/2}(δF/δd). More details concerning nano-indentation experiments may be found in F. J. Balta Calleja & S. Fakirov, Microhardness of Polymer, Cambridge Un. Press, 2000.

The results of the nanoindentation on two coatings are shown in Table 7. The hardness and reduced modulus of the resultant coating of the nano-particles with perfluoroctyl chains only slightly decreased in comparison to the coatings obtained with reference nano-particle A. In comparison to thermoplastics like PMMA, however, the coatings according to the invention still have a higher reduced modulus and display a far better hardness

TABLE 7
Hardness and reduced modulus of a coating obtained with formulation 6 in
comparison to reference coatings

| Coating of formulation | Hardness (GPa) | Reduced modulus (GPa) |
|---|---|---|
| nano-particle A + 0.25% | 1.2 | 24 |
| Irgacure 184 | | |
| Formulation 6 | 0.5 | 14 |
| PMMA | 0.2 | 1-2 |

1. A coating composition comprising reactive nano-particles having reactive organic groups and apolar groups on their surface.

2. A coating composition according to claim 1 also comprising a reactive diluent.

3. A coating composition according to claim 2, which comprises the reactive diluent in such an amount that the coating resulting from the composition has a static contact angle of water is at least 90°.

4. A coating composition according to claim 2, which comprises the reactive diluent in such an amount that the coating resulting from the composition has a static contact angle of water is at least 120°.

5. A coating composition according to claim 1, wherein the reactive diluent contains apolar groups.

6. A coating composition according to claim 5, wherein the reactive diluent contains apolar groups comprising fluor atoms.

7. A coating composition according to claim 1 comprising at least one adhesion promoter.

8. A hydrophobic coating, obtained from the composition according to claim 1.

9. Object comprising a coating according to claim 8.

10. Object comprising a coating in a pattern of both the coating according to claim 8 and a non-hydrophobic coating or the substrate itself.
